(19) United States
(12) Patent Application Publication
(10) Pub. No.: US 2010/0068672 A1
(43) Pub. Date: Mar. 18, 2010

(54) Orthodontic condition evaluation

(76) Inventors: Hossein Arjomand, Cupertino, CA (US); Ken Wu, San Francisco, CA (US); Chunhua Li, Cupertino, CA (US); Jihua Cheng, Cupertino, CA (US)

Correspondence Address: Brooks, Cameron & Huebsch, PLLC, 1221 Nicollet Avenue, Suite 500, Minneapolis, MN, 55403, US

(21) Appl. No.: 12/283,756

(22) Filed: Sep. 16, 2008

(51) Int. Cl. A61C 7/08

(52) U.S. Cl. 433/24

(57) ABSTRACT

Various methods and systems for an orthodontic condition evaluation are provided. One embodiment includes providing an impression kit with an impression material, a number of impression trays, and instructions for making at least one impression, making an impression of a user's teeth, and scanning the impression of the user's teeth with a scanning device and providing scan data to a computing device having executable instructions to perform an evaluation process.

### BACKGROUND

The present disclosure is related generally to the field of orthodontics. More particularly, the present disclosure is related to an orthodontic condition evaluation.

Orthodontic evaluation and treatment systems are typically structured around a traditional appointment with a treatment professional (e.g., dentist or orthodontist) at the treatment professional's office. To make an appointment, the patient must call or stop in to a treatment professional's office so that the treatment professional can physically inspect and evaluate the patient's teeth.

The evaluation process of the patient's teeth includes visual and physical inspection of the patient's teeth. The evaluation occurs when the treatment professional implements traditional diagnostic techniques, such as visually inspecting the patient's teeth, physically testing the structure and strength of the user's teeth, and performing x-rays or other scans of the user's teeth.

Such techniques may include taking an impression of the patient's teeth. The treatment professional then uses his/her learned knowledge to diagnose any orthodontic conditions that the patient may have and can be corrected, before he recommends a corrective action to the patient.

The patient's treatment options are typically limited to those recommended by the treatment professional and/or those that the treatment professional is capable of performing. In order for the patient to benefit from the appointment, office visit, and diagnosis, the patient has to use that particular treatment professional to implement the treatment and pay the treatment professional's rates for their service.

Further, the patient must find and visit other treatment professionals to receive further diagnosis or treatment options. Each treatment professional will have a different skill set and level of expertise and every patient will have a different condition to treat, thus, to find the best suited or experienced doctor for the unique treatment of each patient, the patient must typically visit numerous doctors.

### BRIEF DESCRIPTION OF THE DRAWINGS

FIG. 1 illustrates a method embodiment for evaluating an orthodontic condition according to the present disclosure.

FIG. 2A illustrates an embodiment of an impression of a set of teeth and the digital model of the set of teeth according to the present disclosure.

FIG. 2B illustrates a cross sectional view an embodiment of the digital model of the set of teeth according to the present disclosure.

FIG. 3 illustrates a method embodiment for taking an impression of a user's teeth with an impression kit and evaluating the impression at an analysis center for an orthodontic condition according to the present disclosure.

FIG. 4 illustrates a method embodiment for making an impression of the user's teeth and performing an evaluation process of an orthodontic condition according to the present disclosure.

### DETAILED DESCRIPTION

Embodiments of the present disclosure provide various methods and systems for providing an orthodontic condition evaluation. Various embodiments include providing an impression kit with an impression material, a number of impression trays, and instructions for making at least one impression. An impression can be made of a user's teeth. The impression of the user's teeth can be scanned with a scanning device and scan data can be provided to a computing device having executable instructions to perform an evaluation process.

Embodiments of the present disclosure are described in relation to the accompanying drawings, which will at least assist in illustrating the various features of the various embodiments. In the Figures, the first digit of a reference number refers to the Figure in which it is used, while the remaining two digits of the reference number refer to the same or equivalent parts of embodiment(s) of the present disclosure used throughout the several figures of the drawing.

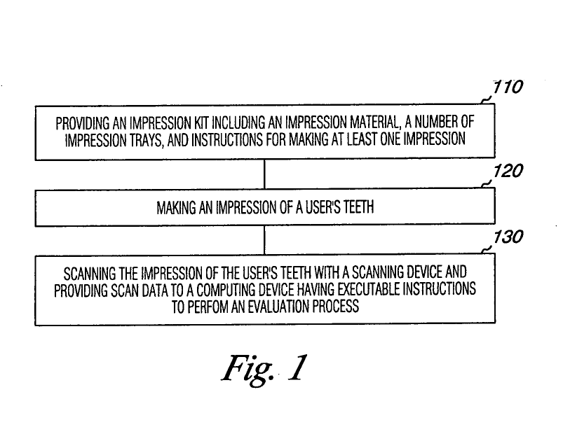

FIG. 1 illustrates a method embodiment for evaluating an orthodontic condition according to the present disclosure. In various embodiments, a method can include providing an impression kit that includes an impression material, a number of impression trays, and instructions for making at least one impression as illustrated by block 110 in the embodiment of FIG. 1.

The impression kit can be a kit that the user purchases in a retail store, a dentist/orthodontist office, on-line, or through any other available purchasing method. Consequently the user can also use the impression kit in the convenience of his/her own home, at a clinic, in the dental office, etc.

The user makes an impression of the user's teeth 120 or have someone may assist them in making the impression by following the simple instructions in the kit. After taking the impression, the user may have the impression scanned with a scanning device so that the scan data can be provided to a computing device having executable instructions to perform an evaluation process 130.

Once the user has completed taking the impression of their teeth, the impression can be used to evaluate the orthodontic condition of the user's teeth. The impression itself can be evaluated and the impression can be used to create a digital model of the user's teeth, which can then be evaluated.

In some embodiments, the evaluation process of the digital model can be automated by comparing the digital model to an existing case indexing database to diagnose the orthodontic condition of the user's teeth to formulate a proposed treatment plan. The process can also be accomplished by review of the digital model and/or the impression by a number of treatment professionals.

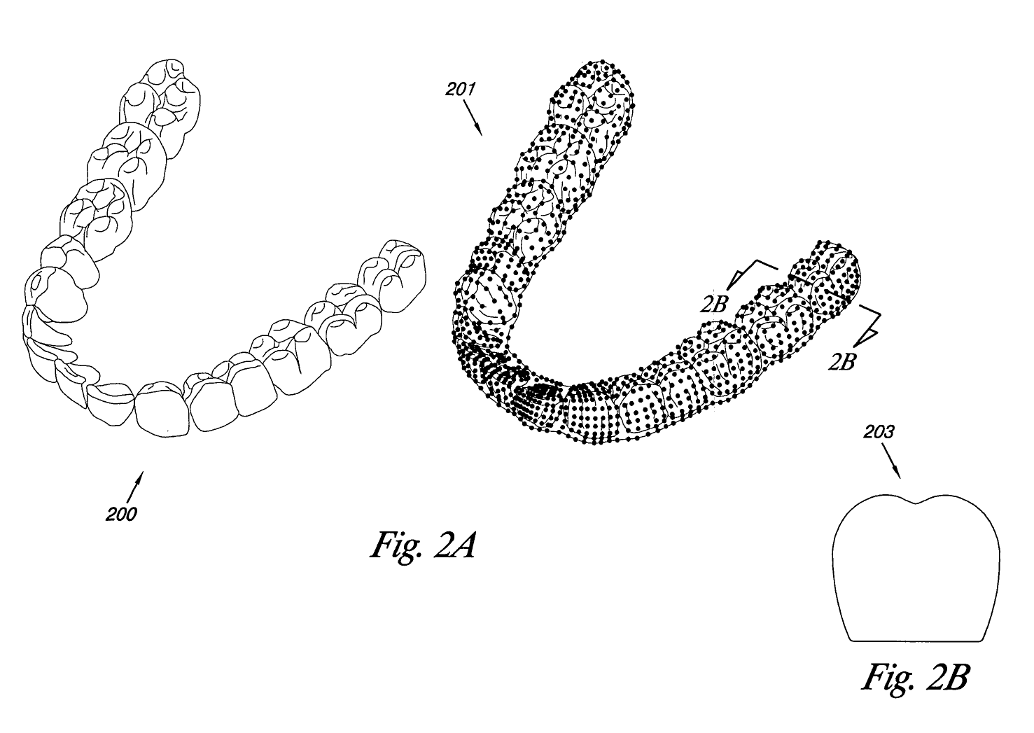

FIG. 2A illustrates an embodiment of an impression of a set of teeth and the digital model of the set of teeth according to the present disclosure. In various embodiments, the impression of the user's teeth 200 can be taken with an impression kit.

The impression of the user's teeth 200 can then be scanned and the data gathered by the scan can then be used to form a digital model of the impression of user's teeth 201. The digital model of the impression of the user's teeth 201 can, for example, provide a digital image of the user's teeth that maps the outside surface of the impression of the user's teeth 200 to allow 360° viewing the user's teeth. The digital model 201 can then be studied by a treatment professional to determine if an orthodontic condition exists with the user's teeth, which can be easier and can be more thoroughly studied for longer time periods than looking into the mouth of the user while the user is at the treatment professional office.

FIG. 2B illustrates a cross sectional view an embodiment of the digital model of the set of teeth according to the present disclosure. In various embodiments, the digital model of the impression of the user's teeth can show a cross sectional view of the user's teeth 203. This view can be beneficial to the treatment professional in evaluating the user's teeth and diagnosing and forming a treatment plan for an orthodontic condition of the user. The cross sectional view of the impression of the user's teeth 203 can provide a unique perspective of the user' teeth that is not available through traditional method such as visual inspection or pictures of the user's teeth.

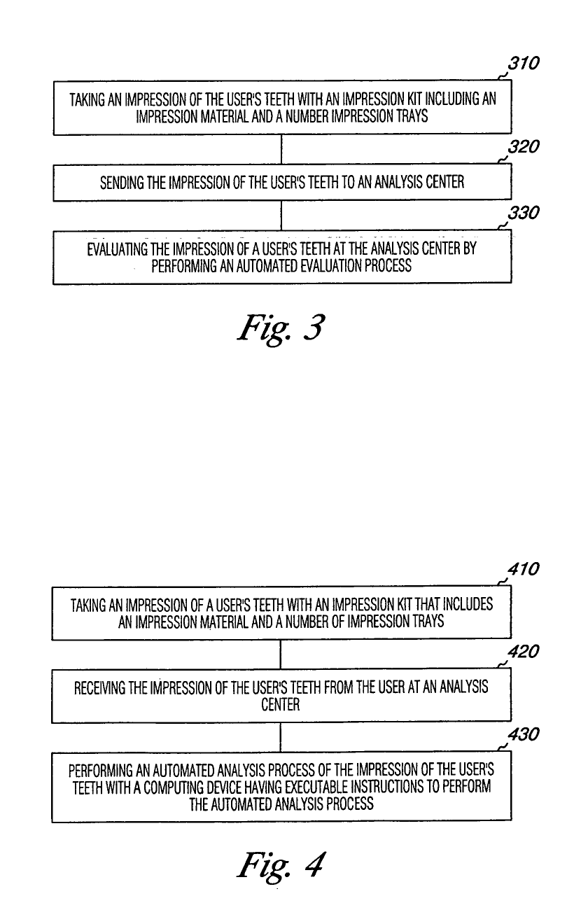

FIG. 3 illustrates a method embodiment for taking an impression of a user's teeth with an impression kit and evaluating the impression at an analysis center for an orthodontic condition according to the present disclosure. The embodiment of FIG. 3 includes taking an impression of the user's teeth with an impression kit including an impression material and a number of impression trays 310.

In some embodiments, the impression trays can hold the impression material. The impression trays that contain the impression material can be inserted into the user's mouth.

The impression trays can be inserted into and removed from the user's mouth one at a time or two impression trays can be used at the same time, for example, where there is an impression tray for the upper teeth of the user and another tray for the lower teeth of the user.

The impression tray can then be removed from the user's mouth. The impression of the user's teeth and gums can then be used as a mold in the making of a cast model of the user's teeth.

The impression kit can be designed, for example, to be portable and/or used in any home by any user or done with the assistance of another, such as an adult or caregiver, among others. The impression kit can be used at a treatment professional's office if the user, for example, would like assistance in taking the impression of their teeth.

In some embodiments, the impression material can be an elastic impression material. An elastic impression material, for example, allows for the impression to be easily formed in the impression material, while retaining the impression of the user's teeth in the material after the material has been removed from the user's mouth, which the user will appreciate when using the impression kit themselves. In some embodiments, elastic impression materials can eliminate the need to mix chemicals together to create the material that can form the impression of the user's teeth.

In various embodiments, the impression kit can include a timer and instructional booklet on how to use the impression kit. The timer in the impression kit can be used, for example, to alert and inform the user of the appropriate amount of time that the impression material should surround the user's teeth while the impression is being formed. In some embodiments, the timer can be pre-set so that the user only has to start the timer when the impression trays are put in the user's mouth and removed when an indicator on the timer (e.g., a buzzer) is activated, for example.

The instructional booklet can, for example, include written instructions for the user to read. In some embodiments, the instructional booklet can include drawings and/or pictures demonstrating the proper use of the impression kit. The instructions and timer can, for example, be important for users that are using the kit on their own, as the process of taking an impression of their teeth may not be a common or intuitive process.

In the embodiment of FIG. 3, the method includes sending the impression of the user's teeth to an analysis center 320. In various embodiments, a method can include various forms of analysis including, for example, undergoing a number of manual or automated evaluations and/or analysis of the impression of the user's teeth by a number of treatment professionals (e.g., inspection and/or diagnosis of one or more orthodontic conditions) at the analysis center.

In some embodiments, a method can include assigning a complexity level to the orthodontic condition of the user based on the analysis of the impression of the user's teeth by a number of treatment professionals. The complexity level can be used to determine potential treatment plans that have been successful in treating similar orthodontic conditions in prior patients, for instance. The complexity level can be used as a guideline to predict the length of the treatment and/or the cost of the treatment.

The embodiment of FIG. 3 can include evaluating the impression of a user's teeth at the analysis center by performing an automated evaluation process 330. For example, in various embodiments, a method includes scanning the impression of the user's teeth with a scanning device to create a digital model of the user's teeth.

In some embodiments, an automated or semi-automated evaluation process can be completed by utilizing computing device executable instructions to create a digital positive or negative model of the impression of the user's teeth based on scan data. For example, the digital model can be used in an evaluation process by treatment professionals who can visually inspect the digital model to provide their analysis. The one or more treatment professionals and/or computing device executable instructions can examine or be used to examine the digital model and/or impression for landmarks, typical tooth or mouth parameters, and X-Y coordinates of teeth, other mapping relationships, and/or other positional or condition related information to find one or more correlations between the prospective patient's orthodontic conditions and that of one or more existing cases.

In some embodiments, an impression of a patient's teeth may not capture all of one or more of a tooth or teeth's geometries. For example, a posterior tooth may not be captured by an impression.

In such instances, a portion of or the entire tooth that is missing in the digital model can be constructed, for example, through use of one or more sets of computing device executable instructions. This construction can be implemented, for instance, by comparing the data of the tooth of the patient with a number of digital typodont models in a database.

As used herein, a typodont model is a model of the teeth of a typical mouth. Since not all mouths are alike, there may be multiple typodont models based upon common variations or common mouth types.

In some embodiments, this process can be accomplished manually, or in some embodiments, automatically through use of a set of executable instructions that can be used to determine the models to compare, make the comparison, and/or provide the missing data or an estimation thereof. In some embodiments, from the comparison, a scaling of the data can be calculated to improve the fit of the typodont data to the actual digital model into which it will be used. Then the scaling can be applied to the typodont model data to generate the missing tooth model data.

After the generation of missing tooth model data, the constructed tooth model may be positioned along with other existing digital tooth models by means of certain algorithms, for example, utilizing the arch form data to aid in the positioning of the constructed tooth model.

Similarly, in some embodiments, only the partial surface of a tooth crown is captured by the impression. For the tooth's digital model, the missing partial surface can be added.

In various embodiments, his can be accomplished manually, through use of computing device executable instructions, for example, having one or more algorithms. In such embodiments, the computing device executable instructions can adjust the digital typodont tooth model.

For instance, as the impression is taken from one or more of the patient's tooth crowns, the root geometry may not be included in the impression. The digital root model can be constructed manually, by addition or other adjustment of the data or by certain algorithms that do such data adjustment, for example, adjusting the patient root information with information from a digital typodont tooth model. The constructed with-root tooth can then be utilized for orthodontic evaluations, among other benefits.

In some embodiments, the digital model may be segmented to separate tooth models. The separate tooth models may be utilized for use with treatment plan or other evaluation processes.

The segmented tooth model can, for example, be useful to evaluate each tooth individually. Such embodiments may create a more realistic view of the treatment plan as the teeth are able to be moved individually with respect to each other.

Various suitable adjustment processes can be used with respect to the various embodiments of the present disclosure. For example, one type of root adjustment process is described in U.S. patent application Ser. No. 11/458,485, published as U.S. Patent Publication No.: 20080020350 assigned to Align Technology, Inc. Another adjustment concept is disclosed in U.S. patent application Ser. No. 11/951,812, also assigned to Align Technology, Inc.

In various embodiments, a method can include developing a treatment plan for the orthodontic condition of the user based on the analysis of the impression of the user's teeth. The treatment plan can include one or more steps involved in treating the orthodontic condition of the user.

In some embodiments, the treatment plan can include a schedule or time line for the treatment plan, including a schedule of the office visits to the treatment professional. In some embodiments, the treatment plan can include a price estimate for the treatment that is based on the complexity of the treatment, the treatment professional performing the treatment, the time frame of the treatment, the method of treatment to be used, and/or the hardware that is used during treatment of the orthodontic condition.

In some embodiments, a treatment plan can be created based upon the comparison of the digital model of the user's teeth to an existing cases indexing database. Various prior treatment plans of prior patients can be stored in an existing cases indexing database. The treatment plan can then be derived from the treatment plans of prior patients by comparing orthodontic conditions of the present patient with former patient's to find one or more correlations that can be used to determine one or more of the above items of information.

In some embodiments, a number of treatment professionals, separately or through collaboration, can analyze the proposed and/or one or more previous treatment plans to develop a recommendation as to the complexity of the case.

In various embodiments, the method can include referring the user to a treatment professional for initiation of the treatment plan based on the evaluation of the impression of a user's teeth at the analysis center. In various embodiments, once a user's teeth have been evaluated, a treatment professional that can perform a recommended treatment plan can be identified.

The treatment professional can, for example, be identified from a list or database of treatment professionals that can provide the services necessary to perform the recommended treatment plan. In some embodiments, the list or database of treatment professionals can be narrowed to include treatment professionals that are located within a certain geographic vicinity of the user, perform the services required for the desired treatment plan, meet a desired cost criteria of the user, or any other metric that the user would like to differentiate available treatment professionals.

In some embodiments, a user receives a list of treatment professionals that can provide the treatment plan. In some such embodiments, the list can be customized to the user based on any criteria they would like their treatment professional to meet.

The list can, for example, provide detailed information about the treatment professional, such as their location, cost, and/or experience, among other characteristics a user would desire to know. The user can then be allowed to evaluate and/or select a treatment professional from the list, if they choose to implement the treatment plan that was recommended to them.

Once the user has selected a treatment professional they would like to work with, the user can initiate the treatment plan with the selected treatment professional. The user can then set up one or more appointments with the treatment professional and the treatment professional can begin to apply the treatment plan to the user's orthodontic condition. In such embodiments, the treatment professional can have knowledge of the user's orthodontic condition prior to their first appointment because the digital model of the user's teeth and/or the impression can be sent to the treatment professional before the appointment, along with a recommended treatment plan.

In some embodiments, the user can receive a rebate for purchasing a treatment plan based on the initiation of the treatment plan. For example, as an incentive for the user to choose one of the treatment professionals from the list to perform the treatment plan, a rebate on the cost of the treatment plan can be given to the user for selecting a treatment professional from the list.

In some embodiments, the cost, discount, and/or benefit information for the treatment plan from each of the treatment professionals and/or a financial credit application to determine financing options for the user to pay for the treatment plan can be given to the user. The financial investment for initiating a treatment plan is a very important aspect of the evaluation process for a user.

The investment may be quite large and can vary depending on the specific treatment professional used and/or the method involved in the treatment plan. Information about the costs, discounts, and/or benefits associated with each of the treatment professionals that were referred to the user as potential treatment professionals to perform the treatment plan can, for example, allow the user to make an informed decision about initiating a treatment plan with a treatment professional.

In some embodiments, a financial credit application can be used to determine the user's ability to pay for the treatment of the orthodontic condition. For example, in some embodiments, as part of the evaluation process, the user can fill out a financial credit application. The financial credit application can be analyzed, for example, to determine if the user is credit worthy to receive a loan to pay for the treatment plan or if a payment plan could fit in with the user's financial wherewithal. This information can be used, in some embodiments, to determine the list of treatment professionals that the user could afford to perform the treatment plan. And, the financial credit application could determine is the user is a suitable candidate for a treatment plan.

In some embodiments, the financial credit application is used to find the user a financing method to pay for the treatment of the orthodontic condition. For instance, the information from the financial credit application can be forwarded to a financial institution which can then, in turn, offer financing options to the user. In some embodiments, the treatment professionals that are on the list given to the user can use the financial credit application information to offer their own financing or payment plan for the treatment plan that they will provide.

FIG. 4 illustrates a method embodiment for making an impression of the user's teeth and performing an evaluation process of an orthodontic condition according to the present disclosure. The embodiment of FIG. 4 includes taking an impression of the user's teeth with an impression kit including an impression material and a number of impression trays at block 410. The taking of an impression of the user's teeth and the impression kit can, for example, include the methods and components described above in association with FIG. 3 at block 310.

In the embodiment of FIG. 4, the method includes receiving the impression of the user's teeth from the user at an analysis center 420. In various embodiments, once the user has obtained the impression of the user's teeth, the impression can be sent to an analysis center.

In the embodiment of FIG. 4, the method includes performing an automated analysis process of the impression of the user's teeth with a computing device having executable instructions to perform the automated process 430. In various embodiments, the method includes scanning the impression of the user's teeth with a scanning device and providing scan data to a computing device having executable instructions to perform an evaluation process.

For example, the analysis center can include equipment and computing devices to perform an evaluation of the impression. This can be accomplished by identifying the types of orthodontic conditions that may exist with the impression and searching a database of prior cases to see if the present patient's conditions match with one or more prior cases. Analysis can then be done by comparing the characteristics of the case to provide information (e.g., time, cost, complexity, issues related to treatment, etc.) to the prospective patient and/or treatment professional.

In some embodiments, treatment professionals can be located at the analysis center to evaluate the impression and to diagnose an orthodontic condition of the user. As discussed above the information provided can also be used to identify one or more treatment professionals for the prospective patient to evaluate.

In various embodiments, the prior patient's data included in the database can include data regarding prior patients that a particular treatment professional has treated and/or it can include the prior patients of a network of treatment professionals that are sharing the existing cases indexing database. The network of shared prior patient data in the existing cases indexing database can give a treatment professional in the network information to use as they diagnose an orthodontic condition of a user while evaluating the digital model of the user's teeth, among other benefits.

In various embodiments, the automated analysis can include a component of assigning a complexity level of the orthodontic condition of the user. The complexity level can, for example, be derived from the comparison of the digital model of the user's teeth with prior patient's case files in the case history database.

The complexity level can be used, for example, to determine potential treatment plans that have been successful in treating similar orthodontic conditions in prior patients. In various embodiments, the complexity level can be used as a guideline to predict the length of the treatment and the cost of the treatment.

In some embodiments, the automated evaluation process can include creating a visual representation of a proposed treatment plan based upon the analysis of the digital model of the impression of the user's teeth by the automated evaluation process. The complexity level can, for example, be used to identify the steps of a proposed treatment plan.

In various embodiments, a visual representation can illustrate one or more steps of the process of the treatment plan and illustrate the progression throughout the treatment plan. In some embodiments, the visual representation of the treatment plan can be compiled using pictures or digital models from prior cases.

Although specific embodiments have been illustrated and described herein, those of ordinary skill in the art will appreciate that any arrangement calculated to achieve the same techniques can be substituted for the specific embodiments shown. This disclosure is intended to cover any and all adaptations or variations of various embodiments of the disclosure.

It is to be understood that the use of the terms “a”, “an”, “one or more”, “a number of”, or “at least one” are all to be interpreted as meaning one or more of an item is present. Additionally, it is to be understood that the above description has been made in an illustrative fashion, and not a restrictive one. Combination of the above embodiments, and other embodiments not specifically described herein will be apparent to those of skill in the art upon reviewing the above description.

The scope of the various embodiments of the disclosure includes any other applications in which the above structures and methods are used. Therefore, the scope of various embodiments of the disclosure should be determined with reference to the appended claims, along with the full range of equivalents to which such claims are entitled.

In the foregoing Detailed Description, various features are grouped together in a single embodiment for the purpose of streamlining the disclosure. This method of disclosure is not to be interpreted as reflecting an intention that the embodiments of the disclosure require more features than are expressly recited in each claim.

Rather, as the following claims reflect, inventive subject matter lies in less than all features of a single disclosed embodiment. Thus, the following claims are hereby incorporated into the Detailed Description, with each claim standing on its own as a separate embodiment.

What is claimed is:

1. A method for evaluating an orthodontic condition, comprising:
providing an impression kit including an impression material, a number of impression trays, and instructions for making at least one impression;
making an impression of a user's teeth; and
scanning the impression of the user's teeth with a scanning device and providing scan data to a computing device having executable instructions to perform an evaluation process.

2. The method of claim 1, where taking the impression of the user's teeth is performed by the user.

3. The method of claim 2, where the method includes analyzing the impression of the user's teeth by a number of treatment professionals.

4. The method of claim 1, where the computing device includes executable instructions to automate a portion of the evaluation process to establish a complexity level for treatment of the user's teeth.

5. The method of claim 4, where the method includes creating a digital model of the impression of the user's teeth.

6. The method of claim 5, where the method includes adjusting the scan data based upon comparison of the scan data with typodont model data.

7. The method of claim 27, where the method includes creating a visual representation of at least one step of a proposed treatment plan based upon the analysis of the digital model of the impression of the user's teeth.

8. The method of claim 1, where the method includes assigning a complexity level to the orthodontic condition of the user based on the analysis of the impression of the user's teeth by a number of treatment professionals.

9. A method for treating an orthodontic condition, comprising:
taking an impression of a user's with an impression kit including an impression material and a number of impression trays;
sending the impression of the user's teeth to an analysis center;
creating a digital model of the impression of the user's teeth; and
evaluating the digital model of the impression of a user's teeth at the analysis center by performing an automated-evaluation process.

10. The method of claim 9, where the method includes assigning a complexity level to the orthodontic condition of the user based on the analysis of the impression of the user's teeth by the evaluation process.

11. (canceled)

12. The method of claim 10, where the method includes developing a treatment plan for the orthodontic condition of the user based on the analysis of the impression of the user's teeth by a number of treatment professionals.

13. The method of claim 9, where the method includes referring the user to a treatment professional for initiation of the treatment plan based on the evaluation of the impression of a user's teeth at the analysis center based upon the evaluation of the impression of a user's teeth.

14. An orthodontic condition evaluation system, comprising:
an impression kit for taking an impression of a user's teeth including an impression material and a number of impression trays;
an analysis center that receives the impression of the user's teeth from the user; and
a computing device having executable instructions for performing at least a portion of an analysis process of the impression of the user's teeth.

15. The system of claim 14, where the impression material is an elastic impression material.

16. The system of claim 14, where the impression kit includes a timer and an instructional booklet on how to use the impression kit.

17. The system of claim 14, where the impression of the user's teeth is completed with an impression kit that provides the user with instructions for taking the impression of their own teeth.

18. The system of claim 14, where the analysis process for the impression of the user's teeth uses an existing cases indexing database to analyze the impression of the user's teeth and to assign a complexity level to the orthodontic condition of the user's teeth.

19. The system of claim 18, where the complexity level of the orthodontic condition of the user's teeth is used to develop a visual representation of a treatment plan.

20. The system of claim 19, where a number of treatment professionals analyze the treatment plan to develop a recommendation as to the complexity of the case.

21. The system of claim 14, where a user is referred to a number of treatment professionals each available for initiation of a treatment plan based on the automated analysis process of the impression of the user's teeth.

22. The system of claim 21, where the system includes cost, discount, and benefit information for the treatment plan from each of the treatment professionals and a financial credit application to determine financing options for the user to pay for the treatment plan.

23. The system of claim 22, where the financial credit application is used to determine the user's ability to pay for the treatment of the orthodontic condition.

24. The system of claim 22, where the financial credit application is used to find the user a financing method to pay for the treatment of the orthodontic condition.

25. The method of claim 5, where the method includes adding typodont model data to the scan data.

26. The method of claim 25, wherein the method includes scaling the typodont model data prior to adding the typodont model data to the scan data.

27. The method of claim 4, where the method includes assigning a complexity level to the orthodontic condition of the user based on the analysis of the digital model of the impression of the user's teeth.
